(19) United States
(12) Patent Application Publication
(10) Pub. No.: US 2008/0241808 A1
(43) Pub. Date: Oct. 2, 2008

(54) EDUCATIONAL BODY PART LEARNING KIT

(76) Inventor: Anthony Badalucca, Rockaway, NY (US)

Correspondence Address: MEREDITH & KEYHANI, PLLC, 330 MADISON AVE., 6TH FLOOR, NEW YORK, NY, 10017, US

(21) Appl. No.: 12/017,641

(22) Filed: Jan. 22, 2008

Related U.S. Application Data
(63) Continuation of application No. 10/395,612, filed on Mar. 24, 2003, now abandoned.

(51) Int. Cl. G09B 23/30; A23G 3/54

(52) U.S. Cl. 434/271; 426/104; 434/272; 434/270; 434/274; 426/103

(57) ABSTRACT

The present invention provides systems and methods to teach individuals information about items, including the human body and body parts utilizing edible prototypes, such as body parts constructed of chocolate. According to one embodiment, an educational learning kit is provided for teaching the different parts, textures and workings of at least one part of the human body, the kit comprising: an edible prototype of a body part, having at least two layers and being anatomically correct in texture and placement and an educational card corresponding to the body part containing information the contains information including the function of the body parts.

This patent is a continuing application to co-pending application Ser. No. 10/395,612 filed Mar. 24, 2003 and entitled “Educational Systems and methods Utilizing Edible Body Parts and Associated Information Cards.”

### BACKGROUND OF THE INVENTION

The present invention generally relates to educational learning kits, systems and methods for teaching the anatomy and more specifically relates to educational systems and methods that are interactive, utilizing edible body parts that are anatomically correct in conjunction with information cards that provide information about the body part.

It is well known that teaching children often involves games and different styles of teaching. Children learn in many different ways including visual, auditory, kinesthetic (through movement) and tactile (through touch). While it is well known that many children require different teaching styles, teachers still teach the human body and other complex structures through the use of generally visual pictures. Because of this, it is no wonder that many children have such difficulty in understanding anatomy and the human body. Often, the parts are seen in one dimensional picture books, where it is extremely difficult to grasp the layers and complexity of the human body. Alternatively, children may be presented with a skeleton or other three dimensional replicas. However, such replicas still lack the ability to touch, move and see the different layers. As such, those children who may benefit from tactile and kinesthetic teaching methods are at a great disadvantage.

U.S. Pat. No. 6,517,407 depicts one attempt to solve the problem of teaching three dimensional, multi-layered objects such as the human anatomy, in two dimensions. The '407 patent discloses a three dimensional interactive book that includes a wheelfold sandwiched between front and rear covers. FIGS. 1-4 depict a three-dimensional interactive book 10 as in the '407 patent. A front cover 12 has an outer surface 14 and an opposite inner surface 16. The front cover 12 has a three-dimensionally contoured element 18. As seen in cross-section in FIG. 2, the contoured element 18 has a convex surface 20 adjacent the front cover outer surface 14 and a concave surface 22 adjacent the front cover inner surface 16. The convex 20 and concave 22 surfaces each have illustrations which correspond to the contoured element 18. The contoured element convex surface 20 includes a first illustration 24 of human sinuses as viewed from the front, and is depicted in FIG. 1. The contoured element concave surface 22 includes a second illustration 26 of human sinuses as viewed from the rear, and is shown in FIG. 4. The book includes a rear cover 28 having an outer surface 30 and an opposite inner surface 32. In addition, the rear cover 28 has a holographic element 34, typically mounted on the outer surface 30, as shown in FIG. 3. The holographic element 34 may also be located on internal pages of the book.

A wheelfold 36 is sandwiched between the front 12 and rear 28 covers. The wheelfold 36 has a wheel 38 rotatably mounted between opposite front 40 and rear 42 panels. The front 40 and rear 42 panels each have an outer edge 44, and the panels 40 and 42 are connected together along the outer edge 44. There is a notch 46 in the outer edge 44 of the front 40 and rear 42 panels. The wheel 38 has a periphery 48, with serrations 50 on the wheel periphery 48, the serrations 50 being exposed along the notch 46. The wheel 38 has a plurality of primary pictorial elements 52, text, illustrations, or holographic Images. The primary pictorial elements 52 typically will include four elements: a depiction of normal sinuses; a depiction of acute rhinosinusitis; a depiction of chronic rhinosinusitis; and a depiction of treatment of rhinosinusitis. One of the primary pictorial elements 52 is visible through a window 54 in one of the panels, usually the front panel 40, as shown in FIG. 4.

The wheelfold 36 includes a secondary pictorial element 56 on the front panel 40 juxtaposed with the window 54. The secondary pictorial element 56 is a depiction of a human head as viewed from the front, and includes a region of the head corresponding with the sinuses. The window 54 is disposed over the region of the head corresponding with the sinuses. Thus, upon manually rotating the wheel 38 by the serrations 50, the primary pictorial elements 52 will be selectively aligned with the secondary pictorial element 56 through the window 54. Selected surfaces, elements, panels and covers have text 60 written thereon, as well as illustrations and graphics printed thereon. Binding means 58 is provided for binding the front cover, the rear cover, and the wheelfold together.

While the '407 patent represents a significant advancement in the art, it is heavy, requires a number of different parts, is complicated to manufacture, and not capable of providing a life like rendition of body parts. Another problem with the prior art is that it does not keep a childs interest. Children may not be interested or able to learn from playing with plastic replicas of body parts. Also, books are not easily expandable to teach a number of different parts and how they fit together.

Also known are a variety of ways in which to decorate food surfaces. For example, there are a variety of methods in the prior art to decorate chocolate surfaces. U.S. Pat. No. 4,946,696 to Nendl et al. relates to the creation of fine patterns in chocolate surfaces using offset printing of a colored cocoa butter pattern on a printing sheet and thereafter embedding it in a molded chocolate surface. U.S. Pat. No. 4,668,521 to Newsteder relates to a process for producing a photographic quality likeness of a photographic image on the surface of a chocolate candy. The method involves the use of a film surface of a photorelief imaged in a photosensitive element such that peaks and valleys are created in the photosensitive element corresponding to the selected image A deformable transfer blanket is cast against the photosensitive element surface to record in a surface of the transfer blanket peaks and valleys corresponding to the selected image. A chocolate material is then cast against the surface of the transfer blanket to record the selected image by peaks and valleys in the surface of the chocolate. U.S. Pat. No. 4,455,320 to Syrmis relates to a method for sculpting a person's face from a photograph onto a chocolate candy by adapting a photographic image of a person's face, converting the adapted image into a transfer medium or die and then embossing such adapted image onto chocolate candy. U.S. Pat. No. 3,303,796 to Novissimo relates to a method for continuously forming three-dimensional confectionery shapes in sheet form by a roll-pressing operation. U.S. Pat. No. 2,304,494 to Cahoon relates to candy-forming machines for continuously molding confectionery products. U.S. Pat. No. 1,522,738 to Miller relates to the production of candy in the form of strips' which are substantially rectangular in cross-section. The above U.S. patents are herein incorporated by reference in their entirety.

U.S. Pat. No. 4,648,829 to Cattani relates to a device for shaping ice creams and food articles that have a thick and creamy nature comprising at least one forming unit including an air-pervious contoured die and drive elements 20 for moving the die, and members operative to supply compressed air to the die from the opposite side thereof to that engagable to articles to be shaped U.S. Pat. No. 4,847,090 to Delia Posta et al. relates to improved confectionery products which are characterized in having a single product body of discrete component parts at least certain of which differ from others in respect to their physical and/or chemical properties. A co-extruded confection product may be shaped via the use of opposed forming dies. The above U.S. patents are herein incorporated by reference in their entirety.

Some known methods have incorporated the use of chilled molds or chilled plunging devices to set chocolate products more rapidly. The following references relate to methods of using chilled molds or molds with chilled plungers. PCT Patent Publication WO 95/32633 to Aasted relates to a method for producing molded shells of fat-containing, chocolate-like masses wherein a mold cavity is filled with a mass and a cooling member having a temperature below O.degree. C. is subsequently immersed in the mass to define a predetermined shell volume between the member and the mold cavity. This publication is incorporated by reference herein in its entirety, UK Patent publication GB 2 070 501 relates to making confections, such as chocolates and the like, of substantially uniform size. The method involves the steps of depositing a gob of flowable confectionery substance onto a surface, surrounding the gob in spaced relationship with an annular mold, exerting pressure upon the gob to cause the gob to spread apart and come into contact with the mold causing the gob to set so as to form a confectionery body in the mold and separating the confectionery body and the molds from one another. Pressure is exerted on the gob by a ram. It is advantageous if each of the annular molds has a hollow circumferential wall and if a cooling fluid circulates through this hollow wall to create a cooling channel so as to obtain a rapid chilling (and thus setting) of the gob. The inner circumference of the mold may have any desired regular or irregular shape, depending upon what shape is desired to impose upon the finished confectionery body. This publication is incorporated by reference herein in its entirety.

European Patent Application 0 589 820 to Aasted relates to a method for producing molded outer shells of fat-containing, chocolate-like masses wherein a mold cavity is filled with a tempered chocolate-like mass which solidifies from the mold cavity inwardly to form the outer shape of the shell, the temperature of the mold cavity being lower than the temperature of the tempered mass. The mold cavity is filled with a chocolate-like mass in an amount which is just slightly larger than the volume of the finished shell. A cooling member, which has preferably been cooled to −15 to −SO.degree. C, is then immersed into the chocolate mass and kept in a fully immersed position for about 2 to 3 seconds. The chocolate-like mass will then solidify rapidly during crystallization from the cooling member and will readily release the cooling member, which can be lifted up and out of the mold of the cavity. This publication is incorporated by reference herein in its entirety.

U.S. Pat. No. 4,426,402 to Kaupert relates to a method and an apparatus for producing chocolate forms using molding tools. During an injection step, the molding tool is cooled with a coolant, wherein one of the molding parts is maintained at about 2O.degree. C, while the other is maintained at a 10 substantially lower temperature of O.degree. C. or less, such as about −5.degree. C. Even lower temperatures, such as −1 O.degree. C. and even −2O.degree. C, are disclosed as acceptable for still faster molding speeds if the formed chocolate body is carefully handled. This U.S. patent is incorporated by reference herein in its entirety.

While a variety of methods are known within the art to create foods, including chocolate, in a number of shapes, the prior has yet to provide systems and methods to create edible prototypes, such as body parts for the purpose of teaching. Accordingly, the present invention fills the need for interactive systems and methods that utilize visual, auditory, kinesthetic and tactile learning techniques to teach the human body and anatomy. Such systems and methods being easy to manufacture, realistic, fun to play with, easy to expand and teach about a part{s) interaction with other parts of the human body.

### SUMMARY OF THE INVENTION

The present invention provides systems and methods to teach individuals about items, including the human body and body parts, utilizing edible prototypes and information cards.

According to one embodiment, a system for learning about the different parts of an item is disclosed, the system comprising: an edible prototype of an item, wherein the edible prototype is comprised of at least one part; and a card containing information that describes each part.

According to another embodiment, an interactive system for teaching the body parts is disclosed, the system comprising: an edible candy prototype made to look like a body part, the edible candy prototype being comprised of an edible mass center and at least one layer in contact with the edible mass center; and a card containing information describing what the edible mass center and each layer is intended to depict.

According to another embodiment, a system for teaching individuals information about at least one part of the human body is disclosed, the system comprising: a plurality of edible portions formed to look like portions of a human body part, the plurality of edible portions being connected together in correct anatomical positions; and a card containing information that describes each portion of a human body part.

According to yet another embodiment, a system for teaching at least one part of the human body is disclosed, the system comprising: a plurality of edible portions, made of at least one of chocolate, sugar, protein, corn syrup, nuts, rice, vanilla, cocoa butter, colorings, milk chocolate, lactose, milk fat, soy lecithin, corn starch, white chocolate, malt, nougat, truffle, peanut butter, caramel, praline, nuts, marshmallow, fudge, puffed grains, cookie, biscuit, wafer, turkish delight, fondants and mixtures thereof. The plurality of edible portions are formed to look like portions of a human body part connected together in correct anatomical positions, such as bones, soft organs, leg, arm, heart, lungs, skeleton, bone, spleen, stomach, liver, muscles, nose, eye, ear, kidneys, bladdar, intestines, brain, nerves and any combination thereof; and a card containing information that describes each portion of a human body part, the information selected from the group consisting of part, details, location, related parts, function, photograph of an actual item, size, weight, position, trivia and any combinations thereof.

The present invention also envisions a method of providing an interactive learning system with an edible candy prototype and associated information card, the method comprising the steps of: depositing an edible mass onto a deposit surface; forming the edible mass into a desired shape thereby at least partially solidifying at least one outer surface layer of the edible mass so as to provide a shaped edible prototype; providing a paper card; and printing information regarding the shaped edible prototype on the paper card.

According to another embodiment, a method of providing an interactive learning system with an edible body part candy prototype and associated information card, is disclosed comprising the steps of: depositing an edible mass onto a deposit surface; forming the edible mass into a shape that depicts a body part, so as to provide an shaped edible body part prototype; providing a plurality of edible layers formed to depict a life like shaped edible prototype, the plurality of edible layers being in communication with the shaped edible body part prototype; providing a paper card; and printing information regarding the edible body part prototype.

These and other features, aspects and advantages of the present invention will become better understood with reference to the following drawings, description and claims.

### BRIEF DESCRIPTION OF THE DRAWINGS

FIG. 1 is a front perspective view of a three-dimensional interactive book according to the prior art;

FIG. 2 is a cross-sectional view of the three-dimensional interactive book of FIG. 1, taken along lines 2-2 of FIG. 1;

FIG. 3 is a rear perspective of the prior art three dimensional book;

FIG. 4 is a perspective view of the prior art three-dimensional interactive book of FIG. 1. showing the book in the open position;

FIGS. 5A-5B is a front view of an edible prototype of a bone structure according to the present invention;

FIG. 6 is a front view of an information card of the edible prototype as in FIG. 5 according to the present invention;

FIG. 7 is a flowchart of a method according to the present invention; and

FIG. 8 is a flowchart of a method according to the present Invention.

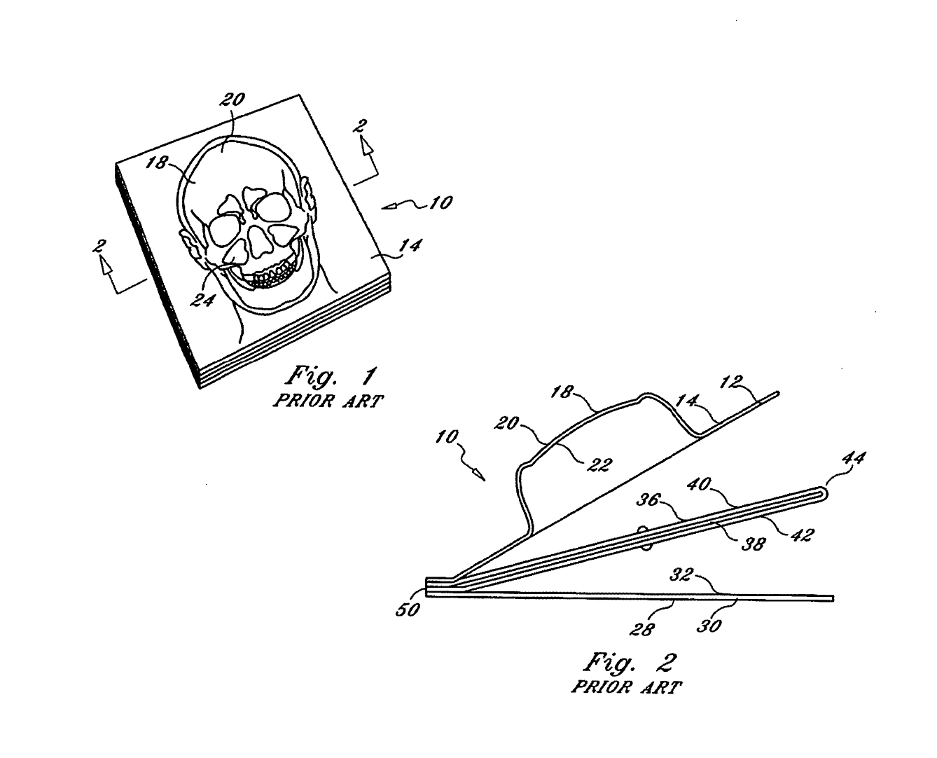

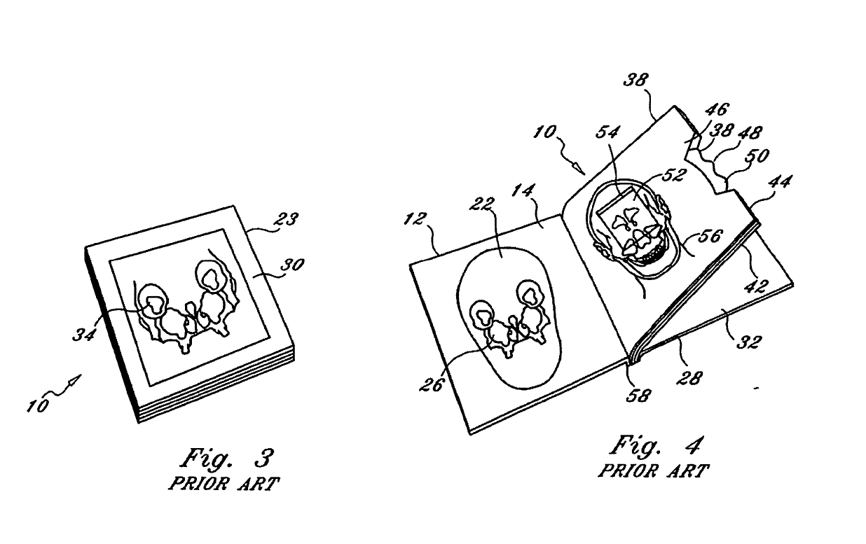

### DETAILED DESCRIPTION OF THE INVENTION

Turning now descriptively to the drawings, wherein similar reference numbers denote similar elements throughout the several views, the attached figures illustrate systems and methods according to the present invention.

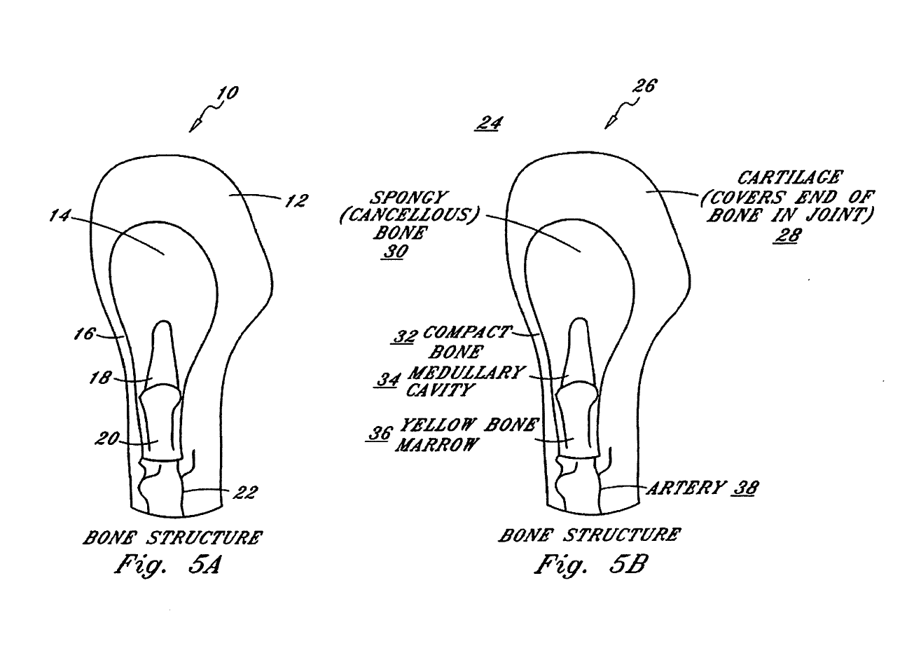

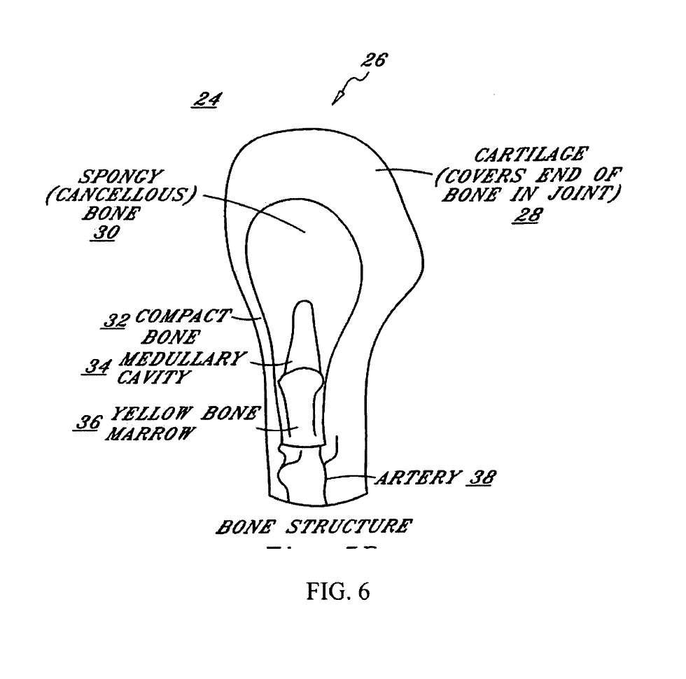

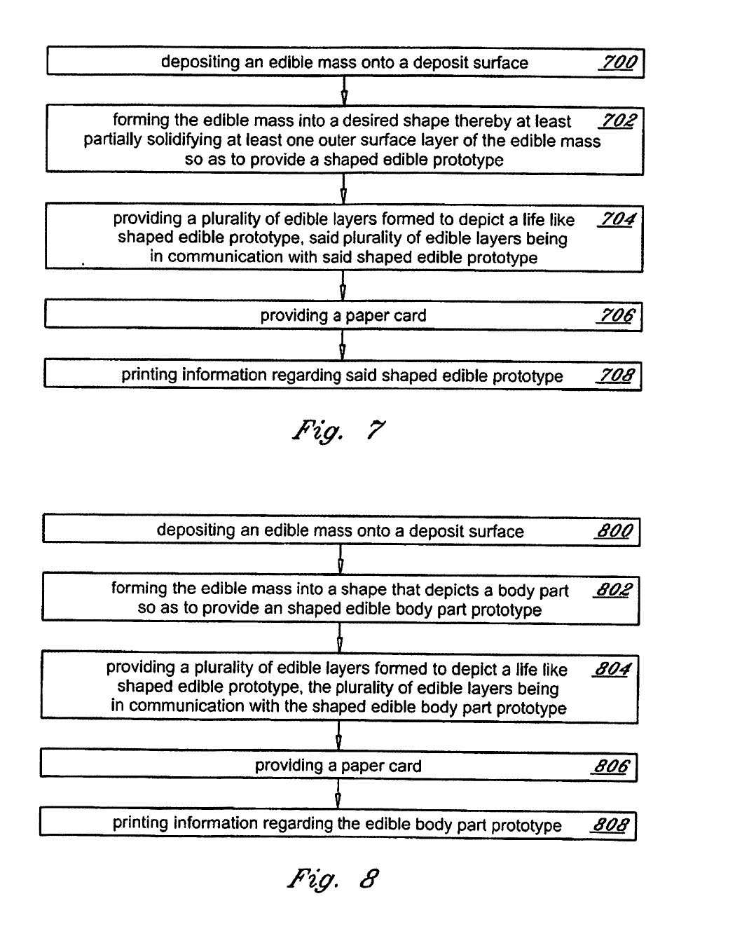

FIG. 5A-5B, 6-8 depict an education learning kit for teaching the different parts, textures and workings of at least one body part as in the present invention. As shown, the kit may have an edible prototype 10 of a body part, wherein the edible prototype 10 is comprised of at least one layer being anatomically correct in texture and placement (e.g. 12.14, 16, 18, 20, 22) and as shown in FIG. 6, an educational card 24 corresponding to the body part and containing information that describes each part and information about the body part, including its function. According to the embodiment shown, the edible prototype 10 is comprised of white chocolate 12 formed to look like cartilage, malt 14 which looks like the 25 spongy bone, white chocolate 16 to form the compact bone, a cavity 18 to look like the medullary cavity, white chocolate with yellow coloring 20 to look like the yellow bone marrow, and Twizzlers® or white chocolate dyed red 22 to look like the arteries. The edible candy prototype 10 may be formed to look like portions of a human body part connected together in correct anatomical positions, the portions of a human body part being selected from the group consisting of bones, soft organs, leg, arm, heart, lungs, skeleton, bone, spleen, stomach, liver, muscles, nose, eye, ear, kidneys, bladder, intestines, brain, nerves and any combination thereof.

It is envisioned that a number of different edible materials could be used in addition to chocolate or candy to create a life like body part. For instance, cheese body parts, protein mixtures, etc. However, the preferred ingredients for the edible prototype is chocolate and candies, as children would be most excited and likely to respond to candy.

It is also envisioned that a number of different methods could be utilized to create the edible prototypes. This may include any of the methods known within the art, including molding, offset printing, transferring photos, etc. The preferred method being molding. The most commonly used method of processing chocolate involves the following sequential steps: complete melting of the chocolate fat phase; cooling to the point of initial crystallization of the fat phase (i.e. below the melting point of the liquid fat phase); crystallizing a portion of the liquid fat phase; slight heating to melt out any unstable crystals that may have formed leaving from about 3 to 8 wt % as seeds for crystallizing the remaining liquid fat; and gently cooling to set the chocolate, typically in a cooling tunnel. During conventional chocolate processing, the chocolate mixture is initially melted at temperatures of about 45° C. and tempered by cooling with agitation to about 29° C. to 30° C. The tempering of the chocolate results in a chocolate dispersion having fat crystals dispersed throughout the liquid fat phase. The chocolate suspension may then be further processed prior to setting by, for example, enrobing the chocolate onto an edible center or molding the chocolate. The chocolate is finally set into a form sufficiently solid for wrapping by gentle, controlled cooling.

Formed chocolate products are conventionally produced by depositing tempered chocolate having a liquid fat phase into molds, allowing the chocolate to cool and harden into solid pieces before demolding the chocolate (Chocolate. Cocoa and Confectionery: Science and Technology by Bernard W. Minifle. Third Edition, pages 198-206, herein incorporated by reference in its entirety). The most commonly used method of producing a shaped chocolate involves the following sequential steps: heating the chocolate to soften, i.e. melting of the fat phase; tempering the chocolate; depositing the tempered chocolate into a mold; shaking the mold to remove air bubbles and fully distribute the chocolate in the mold cavity; cooling to harden the chocolate; and removing said set shaped chocolate from said mold (“de-molding”). Molds and molding are one way to create the edible prototype 10. However, it is envisioned that a number of methods known within the art may be utilized to create life like edible prototypes.

The card 24 according to the embodiment shown, provides a photo 26 of the item which the edible prototype 10 is intended to depict. There is the name of the part, bone structure 28. and a description of different sections or portions of the part 28. For example, cartilage 28. spongy bone 30, compact bone 32, medullary cavity 34 and yellow bone marrow 36. The card 24 may contain a good deal of information regarding the edible prototype, including but not limited to the name of the part, details, location, related parts, function, photograph of an actual item, size, weight, position, and trivia.

The edible candy prototype 10 according to the embodiment shown, is formed of an edible mass center, being the malt 14 portion and layers (e.g. cartilage 12) which are formed upon the malt 14; and a card 24 containing information describing what the edible mass center and each layer is intended to depict. The edible portions, are made of at least one of chocolate, sugar, protein, corn syrup, nuts, rice, vanilla, cocoa butter, colorings, milk chocolate, lactose, milk fat, soy lecithin, corn starch, white chocolate, malt, nougat, truffle, peanut butter, caramel, praline, nuts, marshmallow, fudge, puffed grains, cookie, biscuit, wafer, turkish delight, fondants, fruits and mixtures thereof. As discussed previously, it is envisioned that other edible materials may be used including cheese, ice cream, protein mixtures, and variations thereof.

The present invention also envisions methods for providing an interactive learning system with an edible body part candy prototype 10 and associated information card 24. The method comprising the steps of: step 700 depositing an edible mass onto a deposit surface; step 702 forming the edible mass into a shape that depicts at least a portion of a body part, so as to provide an shaped edible body part prototype; optionally, step 704 may be providing a plurality of edible layers (e.g. 12, 14, 16, 18) formed to depict a life like shaped edible prototype 10; and step 706 providing an information card 24. The edible prototype may be formed of a plurality of layers or layers may be created by added colors.

According to another embodiment, a method for providing an interactive learning kit and system is provided with an edible body part candy prototype 10 and associated information card 24 is disclosed, comprising the steps of: 800 depositing an edible mass onto a deposit surface; 802 forming said edible mass into a shape that depicts a body part (anatomically correct), so as to provide an shaped edible body part prototype; 804 providing a plurality of edible layers formed to depict a life like shaped edible prototype, the plurality of edible layers being in communication with said shaped edible body part prototype; 806 providing a paper card; and 808 printing information regarding the edible body part prototype on the paper card.

An interactive educational learning system for teaching textures, functionalities and interactivity of body parts, said system comprising: an edible candy prototype made to look like a body part, wherein said edible candy prototype is comprised of an edible mass center and at least one layer in contact with said edible mass center, said at least one layer and said edible mass center being anatomically correct in texture and placement; and an educational card containing information describing said edible mass center and each said at least one layer, said educational card containing at least the function of each said body part and naming the anatomical part corresponding to each said edible mass center and said at least one layer.

It should be understood, of course, that the foregoing relates to preferred embodiments of the invention and that modifications may be made without departing from the spirit and scope of the invention as set forth in the following claims.

I claim:

1. An educational learning kit for teaching the different parts, textures and workings of at least one body part, said kit comprising:
an edible prototype of said body part, wherein said edible prototype is comprised of at least one part having at least two layers, said at least two layers being anatomically correct in texture and placement; and
an educational card corresponding to said body part, said educational card containing information that describes at least the function of each said body part and each of said at least two layers.

2. A system as in claim 1, wherein said edible prototype is an edible candy prototype.

3. A system as in claim 1, wherein said item is selected from the group consisting of a human body part, animal body part, reptile body part, bones, soft organs, leg, arm, heart, lungs, skeleton, bone, spleen, stomach, liver, muscles, nose, eye, ear, kidneys, bladder, intestines, brain, nerves and any combination thereof.

4. A system as in claim 1, wherein said edible prototype is made of at least one of chocolate, sugar, protein, corn syrup, nuts, rice, vanilla, cocoa butter, colorings, milk chocolate, lactose, milk fat, soy lecithin, corn starch, white chocolate, malt, nougat, truffle, peanut butter, caramel, praline, nuts, marshmallow, fudge, puffed grains, cookie, biscuit, wafer, turkish delight, fondants, fruits and mixtures thereof.

5. A system as in claim 1, wherein said information consists of at least one of the following: part, details, location, related parts, function, photographs of an actual item, size, weight, position and trivia.

6. An interactive educational learning system for teaching textures, functionalities and interactivity of body parts, said system comprising:
an edible candy prototype made to look like a body part, wherein said edible candy prototype is comprised of an edible mass center and at least one layer in contact with said edible mass center, said at least one layer and said edible mass center being anatomically correct in texture and placement; and
an educational card containing information describing said edible mass center and each said at least one layer, said educational card containing at least the function of each said body part and naming the anatomical part corresponding to each said edible mass center and said at least one layer.

7. A system as in claim 6, wherein said body part is selected from the group consisting of a human body part, animal body part, reptile body part, bones, soft organs, leg, arm, heart, lungs, skeleton, bone, spleen, stomach, liver, muscles, nose, eye, ear, kidneys, bladder, intestines, brain, nerves and any combination thereof.

8. A system as in claim 6, wherein said edible candy prototype is made of at least one of chocolate, sugar, protein, corn syrup, nuts, rice, vanilla, cocoa butter, colorings, milk chocolate, lactose, milk fat, soy lecithin, corn starch, white chocolate, malt, nougat, truffle, peanut butter, caramel, praline, nuts, marshmallow, fudge, puffed grains, cookie, biscuit, wafer, turkish delight, fondants, fruits and mixtures thereof.

9. A system as in claim 6, wherein said edible mass center is made of at least one of chocolate, sugar, protein, corn syrup, nuts, rice, vanilla, cocoa butter, colorings, milk chocolate, lactose, milk fat, soy lecithin, corn starch, white chocolate, malt, nougat, truffle, peanut butter, caramel, praline, nuts, marshmallow, fudge, puffed grains, cookie, biscuit, wafer, turkish delight, fondants, fruits and mixtures thereof.

10. A system as in claim 6, wherein said information consists of at least one of the following: part, details, location, related parts, function, photograph of an actual item, size, weight, position, and trivia.

11. A method of providing of interactive learning kit with an edible candy prototype and associated information card, comprising the steps of:
depositing an edible mass onto a deposit surface;
forming said edible mass into an anatomically correct shape thereby at least partially solidifying at least one outer surface layer of said edible mass so as to provide a shaped edible prototype; and
providing a information card, wherein said information card provides anatomical information regarding said edible candy prototype.

12. A method as in claim 11, wherein said step of forming said edible mass into an anatomically correct shape, is further comprised of the steps of:
providing a plurality of edible layers is communication with said edible mass, said plurality of edible layers formed to be anatomically correct.

13. A method as in claim 11, wherein said shaped edible prototype is selected from the group consisting of chocolate, sugar, protein, corn syrup, nuts, rice, vanilla, cocoa butter, colorings, milk chocolate, lactose, milk fat, soy lecithin, corn starch, white chocolate, malt, nougat, truffle, peanut butter, caramel, praline, nuts, marshmallow, fudge, puffed grains, cookie, biscuit, wafer, turkish delight, fondants, fruits and mixtures thereof.

14. A method as in claim 11, wherein said anatomically correct shape is selected from the group consisting of soft organs leg, arm, heart, lungs, skeleton, bone, spleen, stomach, liver, muscles, nose, eye, ear, kidneys, bladder, intestines, brain, nerves and any combination thereof.

15. A method as in claim 11, wherein said information is selected from the group consisting of part, details, location, related parts, function, photograph of an actual item, size, weight, position, trivia and any combinations thereof.
